(19) United States
(12) Patent Application Publication
(10) Pub. No.: US 2012/0313029 A1
(43) Pub. Date: Dec. 13, 2012

(54) VALVE FOR CONTROLLING A FLUID

(75) Inventors: Andreas Karl, Benningen/Neckar (DE); Andreas Lechler, Vaihingen/Enz (DE); Jens Norberg, Stuttgart (DE)

(73) Assignee: Robert Bosch GmbH, Stuttgart (DE)

(21) Appl. No.: 13/491,719

(22) Filed: Jun. 8, 2012

(30) Foreign Application Priority Data
Jun. 9, 2011 (DE) 10 2011 077 252.9

(51) Int. Cl. F16K 1/36

(52) U.S. Cl. 251/333

(57) ABSTRACT

A valve for controlling a fluid includes a valve seat and a closing body which has a spherical-cap-shaped end region and which is configured to open up and close off a passage at the valve seat. The closing body is rotatably mounted on a bearing and has at least one contouring formed on a surface of the closing body. The contouring is configured to set the closing body in rotation.

This application claims priority under 35 U.S.C. §119 to patent application no. DE 10 2011 077 252.9, filed on Jun. 9, 2011 in Germany, the disclosure of which is incorporated herein by reference in its entirety.

### BACKGROUND

The present disclosure relates to a valve for controlling a fluid with a rotational force imparted in a targeted manner to a closing body.

Valves for controlling a fluid are known in a variety of embodiments from the prior art, and are used in particular for example as inlet valves for anti-lock devices (ABS devices) in motor vehicles. Depending on the operating conditions, however, in said valves, vibrations arise in the closing body during regular operation, which vibrations may lead to mechanical contact with the valve seat, resulting in mechanical loading being exerted on the closing body. If continuous contact occurs at the same point, damage to the closing body may be caused here.

### SUMMARY

By contrast, the solenoid valve according to the disclosure for controlling a fluid has the advantage that a continuous change in position of the closing body in relation to the valve body is effected by means of a geometric form of the closing body. In this way, it is prevented that vibrations of the closing body during regular operation cause always the same points on the circumference of the closing body to be loaded. This is achieved according to the disclosure in that the valve comprises a valve seat and a closing body with a spherical-cap-shaped end region, wherein the closing body opens up and closes off a passage at the valve seat. Furthermore, the closing body, which is rotatably mounted on a bearing, has at least one contouring which is formed on a surface of the closing body and which sets the closing body in rotation when the valve is open. Mechanical loading which may occur can therefore be distributed over the circumference of the closing body. This results in a considerably lengthened service life of the closing body, which is often produced from a temperature-dependent plastic material. The valve can preferably be used as an actuating valve/inlet valve in anti-lock devices (ABS devices).

The subclaims present preferred refinements of the disclosure.

In a particularly preferred embodiment of the disclosure, the contouring is a helically encircling depression. In this way, a part of the fluid flow flowing around the closing body flows in the helically encircling depression and thereby generates rotational forces about a longitudinal axis of the closing body. As a result of the rotation of the closing body, any vibration-induced contact which may occur at the valve seat during regular operation always occurs at different points over the circumference of the spherical-cap-shaped end region.

The helically encircling depression preferably has an inlet region, which is of streamlined form, into the depression. In this way, the fluid flow enters into the depression with the least possible resistance and in as turbulence-free a manner as possible.

In a further advantageous embodiment of the disclosure, the contouring is a helically encircling edge, or a helically encircling profile which protrudes from the closing body, with a constant pitch. Here, the fluid flow which impinges on the edge or the profile exerts forces on the edge or profile surface. Here, a respective force component acting tangentially on the closing body generates a torque about the longitudinal axis of the closing body, which torque causes said closing body to rotate.

In a preferred embodiment of the disclosure, the edge or the profile is formed so as to be helically encircling at least over 360°. In this way, a substantially stable rotation of the closing body is attained substantially without deflections from its central axis direction.

It is furthermore preferable for a transition from the surface of the closing body to the contouring to be of streamlined design. This permits a closely fitting, low-resistance fluid flow with little turbulence.

The contouring preferably begins downstream, in a throughflow direction, of a sealing line at the spherical-cap-shaped end region. This ensures continuously operationally reliable sealing between the closing body and valve seat. Furthermore, in this way, mechanical contact between the valve seat and the closing body in the region of the contouring is not possible.

It is furthermore preferable for the geometric form of the contouring to be uniform and/or for the contouring to have a constant pitch. In this way, substantially symmetrical force conditions or flow conditions are ensured which substantially prevent a wobbling motion of the rotating closing body in the fluid flow during regular operation. The pitch of the contouring may alternatively also vary.

In a preferred embodiment of the disclosure, the closing body has, in the throughflow direction, a continuously widening region in which the contouring is formed. In this way, tangential forces are exerted on the closing body which increase in the throughflow direction. Furthermore, in this way, a particularly streamlined, closely fitting flow around the closing body is attained, which permits precise and operationally reliable regular operation.

The valve is preferably a valve which is open or closed in the deenergized state.

### BRIEF DESCRIPTION OF THE DRAWINGS

Exemplary embodiments of the disclosure will be described in detail below with reference to the appended drawing, in which:

FIG. 1 shows a schematic, partially sectional illustration of the valve according to the disclosure according to a first exemplary embodiment of the disclosure,

FIG. 2 shows a plan view of a closing body of the valve from FIG. 1,

FIG. 3 shows a schematic view of the valve according to the disclosure according to a second exemplary embodiment of the disclosure, and

FIG. 4 shows a schematic sectional illustration of the valve according to a third exemplary embodiment of the disclosure.

### DETAILED DESCRIPTION

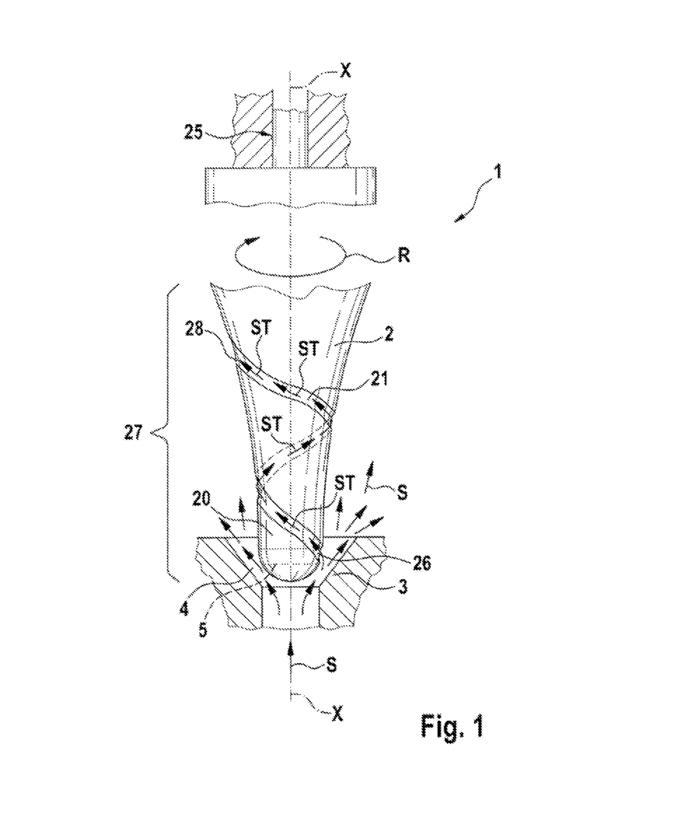

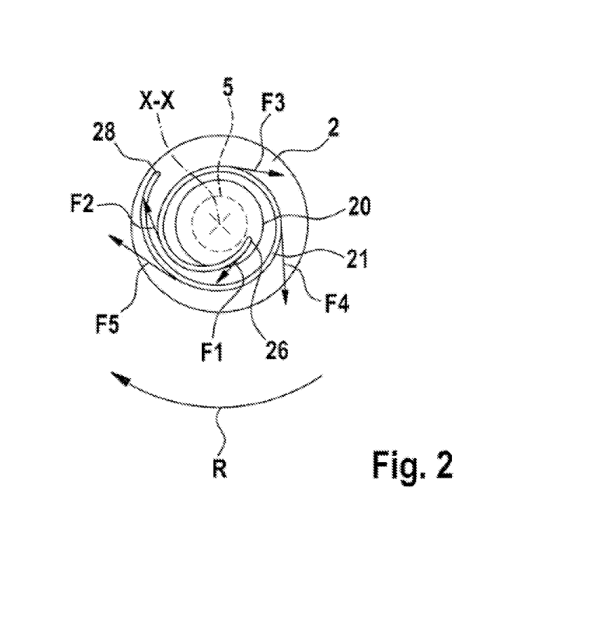

A valve 1 for controlling a fluid according to a first preferred exemplary embodiment of the disclosure will be described in detail below on the basis of FIGS. 1 and 2.

FIG. 1 shows the valve 1 which comprises a closing body 2 and a valve seat 3. The closing body 2 is rotatably mounted on a bearing 25 and has a spherical-cap-shaped end region 20. The closing body is alternatively mounted and guided in a cylindrical valve insert. A central axis is denoted by X-X. FIG. 1 shows the valve 1 in a partially opened stroke position, in which a fluid is supplied at high pressure in the direction of the central axis X-X. The fluid flow, in a throughflow direction S indicated by arrows, is diverted at the closing body 2 into an opened-up annular passage 4 between the closing body 2 and the valve seat 3.

The closing body 2 has, on its surface, a contouring in the form of a helically encircling depression 21 which is formed in a continuously widening region 27 of the closing body 2. The helically encircling depression 21 has a pitch which is constant over the region 27 and has a uniform geometric form. The depression 21 begins downstream, in the throughflow direction S, of a sealing line 5 on the spherical-cap-shaped end region 20 and has a streamlined inlet region 26 through which a partial fluid flow ST indicated by arrows flows in and follows the depression 21.

As can also be seen from FIG. 1, the depression 21 is formed on the closing body 2 over an angular range of 540° (1.5 revolutions). The partial fluid flow ST thereafter emerges out of the depression 21 again at an outlet region 28.

Owing to the helically encircling shaping of the depression 21, tangential forces F1, F2, F3, F4, F5 indicated by arrows are generated, as indicated in FIG. 2, by means of the fluid flow ST in the depression 21. The forces F1, F2, F3, F4, F5 which act in the circumferential direction cause a clockwise rotation R, indicated by an arrow, of the closing body 2 about the central axis X-X. Here, the magnitude of the tangential forces F1, F2, F3, F4, F5 increases along the helical profile of the depression 21 proceeding from the inlet region 26.

The valve 1 according to the disclosure therefore has the advantage that, as a result of the geometric shaping or external form of the closing body 2, a part of the fluid flow generates forces which act tangentially or in the circumferential direction in a targeted manner on the closing body 2. In this way, in regular operation, the closing body 2 is set continuously in rotation, such that an abutment of the oscillating closing body 2 is distributed over the entire circumference of the spherical-cap-shaped end region 20. It is thereby possible for the loading of the closing body 2 and the risk of damage to the surface of the closing body 2 and/or of the valve seat to be considerably reduced, resulting in a considerably longer service life.

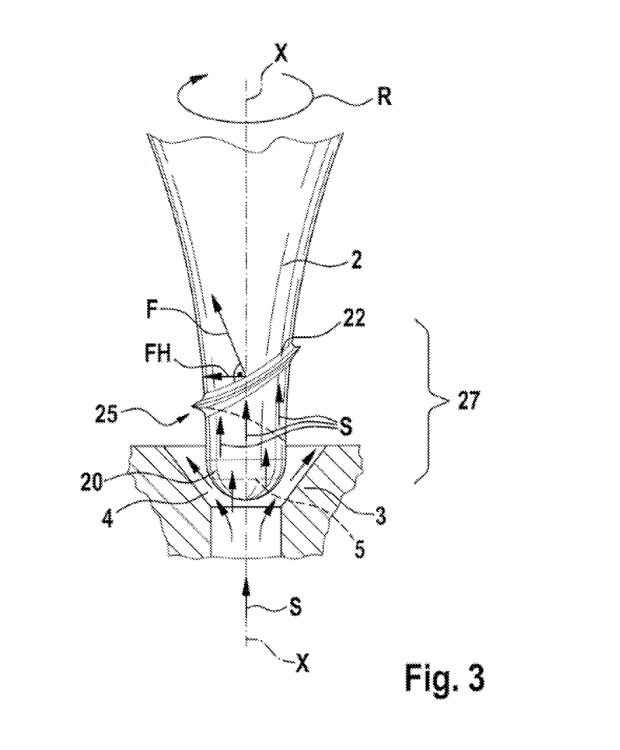

A valve 1 according to a second exemplary embodiment of the disclosure will be described in detail below with reference to FIG. 3. Here, identical or functionally identical components are denoted by the same reference symbols as in the first exemplary embodiment.

In contrast to the first exemplary embodiment described above, instead of the depression 21, there is provided a contouring in the form of a protruding edge 22 which is formed on the closing body 2 with a constant pitch and so as to be helically encircling over an angular range of 360°. Here, a transition 25 in the throughflow direction S from the surface of the closing body 2 to the edge 22 is of streamlined design. Here, as flow passes around the closing body 2, the fluid flow generates forces acting in each case perpendicular to the surface of the edge 22, of which forces only one force F is illustrated here by way of example. As can also be seen from FIG. 3, it is the case here that a tangential force component FH of the force F generates the rotation R of the closing body 2 about the central axis X-X.

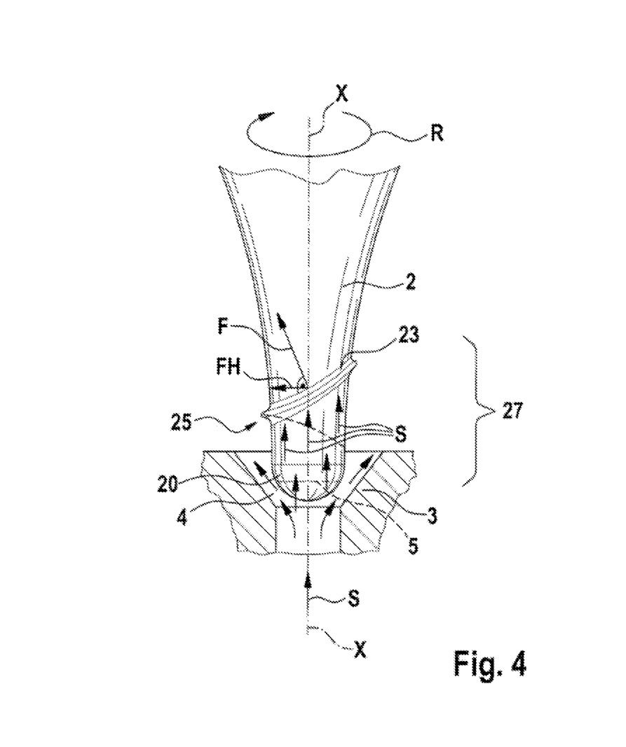

A valve 1 according to a third exemplary embodiment of the disclosure will be described in detail below with reference to FIG. 4. Here, identical or functionally identical components are denoted by the same reference symbols as in the first and second exemplary embodiments.

Here, in contrast to the second exemplary embodiment, instead of the edge 22, there is provided on the closing body 2 a contouring in the form of a protruding profile 23 which is helically encircling over an angle of 360°. Here, to generate the rotation, the same force conditions as in the second exemplary embodiment prevail at the profile 23, such that reference may be made to the description above.

What is claimed is:

1. A valve for controlling a fluid, comprising:
a valve seat, and
a closing body having a spherical-cap-shaped end region, the closing body being configured to open up and close off a passage at the valve seat,
wherein the closing body is rotatably mounted on a bearing, and
wherein the closing body has at least one contouring formed on a surface of the closing body, the contouring being configured to set the closing body in rotation.

2. The valve according to claim 1, wherein the contouring is a helically encircling depression.

3. The valve according to claim 2, wherein the helically encircling depression has an inlet region of streamlined form.

4. The valve according to claim 1, wherein the contouring is a helically encircling edge or a helically encircling profile which protrudes from the closing body.

5. The valve according to claim 4, wherein the edge or the profile is configured to be helically encircling at least over 360°.

6. The valve according to claim 4, wherein a transition from the surface of the closing body to the contouring is of streamlined design.

7. The valve according to claim 1, wherein the contouring begins downstream, in a throughflow direction, of a sealing line at the spherical-cap-shaped end region.

8. The valve according to claim 1, wherein the contouring has one or more of a geometric form that is uniform and a constant pitch.

9. The valve according to claim 1, wherein the closing body has a continuously widening region in which the contouring is formed.

10. The valve according to claim 1, wherein the valve is closed in the deenergized state.
